(19) United States
(12) Patent Application Publication
(10) Pub. No.: US 2025/0233187 A1
(43) Pub. Date: Jul. 17, 2025

(54) APPARATUS FOR MANUFACTURING FUEL CELL STACK

(71) Applicant: HONDA MOTOR CO., LTD., Tokyo (JP)

(72) Inventor: Keita IWAYA, Saitama (JP)

(21) Appl. No.: 18/991,828

(22) Filed: Dec. 23, 2024

(30) Foreign Application Priority Data
Jan. 12, 2024 (JP) 2024-003500

(51) Int. Cl. H01M 8/248

(52) U.S. Cl. CPC H01M 8/248

(57) ABSTRACT

An apparatus for manufacturing a fuel cell stack that can be fastened with an appropriate load for each fuel cell stack is provided. An apparatus 1 for manufacturing a fuel cell stack 10 includes a press 72 that presses the fuel cell stack 10 before fastening along a stacking direction 101, an overall load detector 74 that, when the press 72 presses, detects a load of the fuel cell stack 10, and a calculator 79 that calculates a load per unit time for a load detected by the overall load detector 74. The press 72 stops pressing in a case in which the load per unit time calculated by the calculator 79 is equal to or greater than a first predetermined value.

### CROSS REFERENCE TO RELATED APPLICATIONS

This application claims the benefit of priority to Japanese Patent Application No. 2024-003500 filed on Jan. 12, 2024. The entire contents of this application are hereby incorporated herein by reference.

### BACKGROUND OF THE INVENTION

### Field of the Invention

The present invention relates to an apparatus for manufacturing a fuel cell stack including a stacked body in which a plurality of power generation cells are stacked.

### Related Art

The polymer electrolyte fuel cell includes an electrolyte membrane/electrode assembly (MEA). Electrodes are respectively provided on both sides of the solid polymer electrolyte membrane of the electrolyte membrane/electrode assembly. A seal member is provided on the outer periphery of the electrolyte membrane/electrode assembly. The seal member is a member for preventing leakage of fuel gas, coolant, and the like. The electrolyte membrane/electrode assembly is sandwiched between separators to provide a power generation cell. A stacked body is provided by stacking a number of power generation cells required to obtain a desired voltage. The stacked body is used in the form of a fuel cell stack to which end plates or the like are attached.

Patent Document 1: Japanese Unexamined Patent Application, Publication No. 2012-185920

### SUMMARY OF THE INVENTION

The manufacturing process of the fuel cell stack includes a stack fastening operation. The stack fastening operation includes, for example, pushing and seating the lid against the stack case and screwing the lid onto the stack case. In such a stack fastening operation, conventionally, the pressing operation of the lid against the stack case is stopped based on the height of the lid after pushing, the pushing amount of the lid, the magnitude of the load when pushing the lid, or the like.

The thickness of the components constituting the fuel cell stack may include variations. Therefore, even if the pressing operation is stopped under the same conditions, the load applied to the stack case may be different. That is, in the conventional stack fastening operation, it is difficult to control the load applied to the stack case when the lid is seated on the stack case.

Therefore, an object of the present invention is to provide an apparatus for manufacturing a fuel cell stack that can be fastened with the appropriate load for each fuel cell stack.

The present invention is directed to an apparatus for manufacturing a fuel cell stack, the apparatus including: a press that presses the fuel cell stack before fastening along a stacking direction; an overall load detector that, when the press presses, detects a load of the fuel cell stack; and a calculator that calculates a load per unit time for a load detected by the overall load detector. The press stops pressing in a case in which the load per unit time calculated by the calculator is equal to or greater than a first predetermined value.

According to the above-described apparatus for manufacturing a fuel cell stack, it is possible to provide an apparatus for manufacturing a fuel cell stack that can be fastened with an appropriate load for each fuel cell stack.

The calculator calculates a rate of change of the load per unit time, and the first predetermined value can be set as a value equal to or greater than a value of the load per unit time when the rate of change becomes a second predetermined value.

According to the above-described apparatus for manufacturing a fuel cell stack, it is possible to determine the first predetermined value appropriately.

The fuel cell stack includes a stack case, and the first predetermined value can be set as a value equal to or greater than a value of the load per unit time when the rate of change becomes the second predetermined value, and a value less than a value of the load per unit time when a limit load for the stack case is applied to the stack case.

According to the above-described apparatus for manufacturing a fuel cell stack, it is possible to perform fastening with sufficient strength without applying a load more than a limit to the stack case.

According to the present invention, it is possible to provide an apparatus for manufacturing a fuel cell stack that can be fastened with the appropriate load for each fuel cell stack.

### BRIEF DESCRIPTION OF THE DRAWINGS

FIG. 1 is a perspective view of a fuel cell stack according to an embodiment of the present invention;

FIG. 2A is a view showing an apparatus for manufacturing a fuel cell stack before seating according to the present embodiment;

FIG. 2B is a view showing the apparatus for manufacturing the fuel cell stack after seating according to the present embodiment;

FIG. 3 is a diagram showing an outline of a contact load detection stop; and

FIG. 4 is a graph showing the relationship between the stack length of the fuel cell stack and the load per unit time applied to the fuel cell stack by a pressing unit.

### DETAILED DESCRIPTION OF THE INVENTION

### Fuel Cell Stack

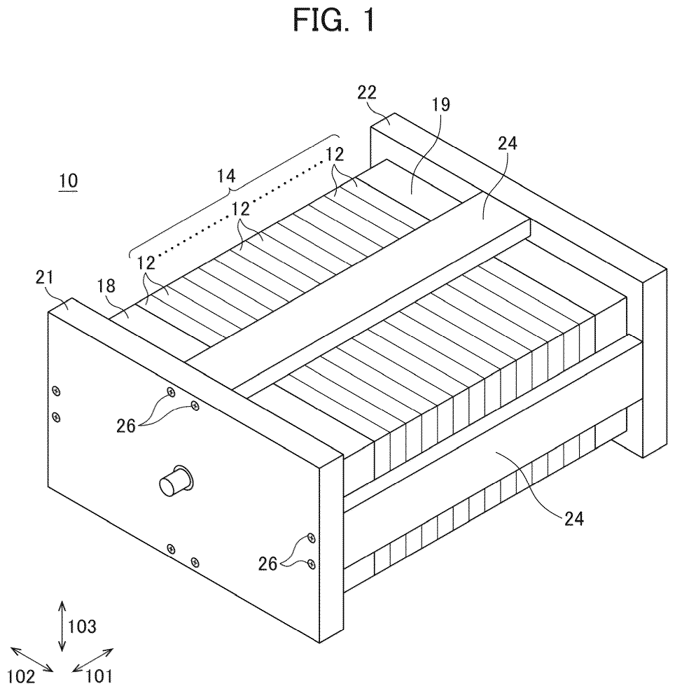

An apparatus 1 for manufacturing a fuel cell stack 10 according to an embodiment of the present invention will be described. Before describing the manufacturing apparatus 1, the fuel cell stack 10 will be described. FIG. 1 is a perspective view of the fuel cell stack 10 according to the present embodiment. The fuel cell stack 10 includes a stacked body 14. The stacked body 14 includes a plurality of stacked power generation cells 12.

### Power Generation Cell and Stacked Body

Each of the power generation cells 12 has a structure in which an electrolyte membrane/electrode assembly is sandwiched between electrically conductive separators. A resin frame member is provided around the electrolyte membrane/electrode assembly. Further, a seal member is provided at an outer peripheral end portion of each of the separators. The seal member is made of an elastic material such as rubber. A stack of the plurality of power generation cells 12 is referred to as the stacked body 14. The stacked body 14 includes an electrode stacked portion and a seal stacked portion. The electrode stacked portion is a portion in which the electrolyte membrane/electrode assembly is mainly stacked. The seal stacked portion is a portion in which the seal members are stacked.

FIG. 1 shows a first direction 101, a second direction 102, and a third direction 103. The first direction 101, the second direction 102, and the third direction 103 are orthogonal or substantially orthogonal to one another. The first direction 101 is a direction in which the power generation cells 12 are stacked. The first direction 101 is referred to as a stacking direction 101.

At one end of the stacked body 14 in the stacking direction 101, a first insulator 18 and a first end plate 21 are provided in this order toward the outside of the stacked body 14. At the other end of the stacked body 14 in the stacking direction 101, a second insulator 19 and a second end plate 22 are provided in this order toward the outside of the stacked body 14. The material of the insulator is, for example, an insulating material such as polycarbonate and phenol resin. A spacer may be provided between the stacked body 14 and the end plate.

As shown in FIG. 1, each of the end plates has a rectangular shape. A coupling bar 24 is provided between opposing sides of the first end plate 21 and the second end plate 22. Both ends of the coupling bar 24 are fixed to the respective end plates by bolts 26. The distance between the first end plate 21 and the second end plate 22 is fixed by fixing both end plates via the coupling bar 24. A fastening load in the stacking direction 101 is applied to each power generation cell 12.

FIG. 1 shows the fuel cell stack 10 fastened using the first end plate 21, the second end plate 22 and the coupling bar 24. The configuration of the fuel cell stack 10 is not limited to the configuration of FIG. 1. For example, the fuel cell stack 10 may be fastened using a stack case and a lid.

### Apparatus for Manufacturing Fuel Cell Stack

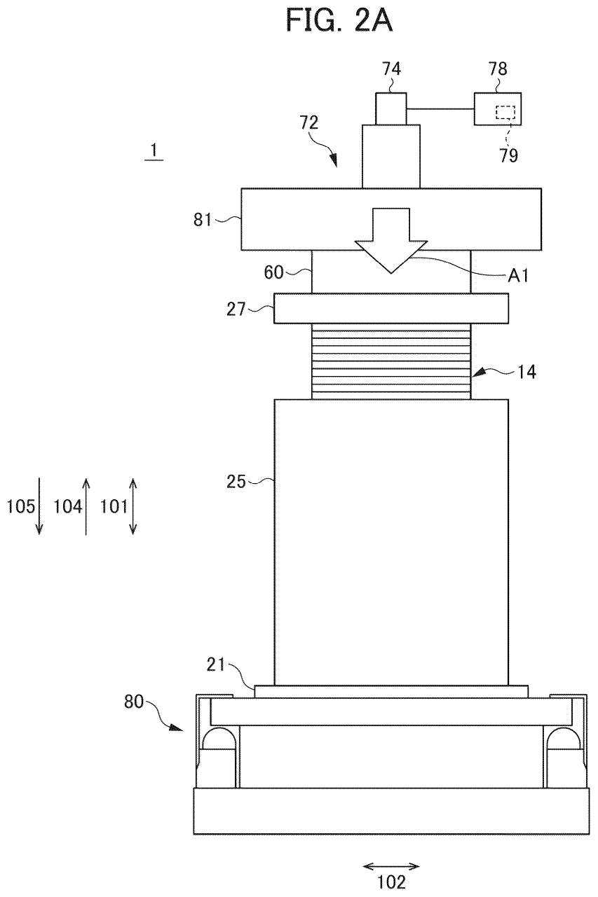

The apparatus 1 for manufacturing the fuel cell stack 10 will be described with reference to FIGS. 2A and 2B. FIGS. 2A and 2B are views showing the apparatus 1 for manufacturing the fuel cell stack 10 of the present embodiment. FIG. 2A shows the apparatus 1 for manufacturing the fuel cell stack 10 before seating. FIG. 2B shows the apparatus 1 for manufacturing the fuel cell stack 10 in a seated state.

As shown in FIGS. 2A and 2B, the apparatus 1 for manufacturing the fuel cell stack 10 mainly includes a pressing unit 72, an overall load detection unit 74, a control unit 78, a pressing plate 81, a fixing member 60, and a holding table 80. As shown in FIGS. 2A and 2B, in the stacking direction 101, a direction indicated by an arrow 104 is referred to as an upward direction 104. In the stacking direction 101, a direction indicated by an arrow 105 is referred to as a downward direction 105. The holding table 80 is provided to the manufacturing apparatus 1 on the lower side in the downward direction 105. The pressing plate 81 is provided to the manufacturing apparatus 1 on the upper side in the upward direction 104. The stacked body 14 as a part of the pressing target is installed between the holding table 80 and the pressing plate 81. The pressing target refers to an object that is provided between the holding table 80 and the pressing plate 81, and is pressed by the pressing plate 81.

### Pressing Unit

The pressing unit 72 presses the pressing target in the downward direction 105 by bringing the pressing plate 81 close to the holding table 80. The downward direction 105 is referred to as a pressing direction. The pressing unit 72 can apply a load to the pressing target. The pressing unit 72 is, for example, a press mechanism such as a servo press.

### Pressing Plate

The pressing plate 81 is a portion that applies a load to the pressing target by being pressed by the pressing unit 72. The fixing member 60 is provided between the pressing plate 81 and the pressing target. The holding table 80 is a portion on which the pressing target such as the fuel cell stack 10 is placed.

The overall load detection unit 74 is a unit for detecting the overall load applied to the entire pressing target. The entire pressing target includes the electrode stacked body portion and the seal stacked portion. The overall load detection unit 74 is constituted by, for example, a load cell. The overall load detection unit 74 detects a load applied to the pressing plate 81 pressed against the pressing target, and outputs the detection result to the control unit 78.

### Control Unit

The control unit 78 is a part that controls the operation of the manufacturing apparatus 1. The control unit 78 controls the pressing unit 72 to adjust a force pressing the pressing plate 81, a speed at which the pressing plate 81 is moved, a timing at which the pressing plate 81 is stopped, and the like. The load detected by the overall load detection unit 74 is inputted to the control unit 78. The control unit 78 includes a calculation unit 79. The calculation unit 79 calculates a load per unit time with respect to the load detected by the overall load detection unit 74. Further, the calculation unit 79 calculates a rate of change of the load per unit time. The control unit 78 can stop the pressing of the pressing plate 81 by the pressing unit 72, when the load per unit time calculated by the calculation unit 79 or the calculated rate of change of the load per unit time becomes equal to or more than a predetermined value.

### Stack Fastening Operation

The stack fastening operation will be specifically described with reference to FIGS. 2A and 2B. FIGS. 2A and 2B show an example in which the lid 27 is brought into contact with the stack case 25 from above. The contact of the lid 27 with the stack case 25 is referred to as seating.

FIG. 2A shows a state before seating in the stack fastening operation. In the stack fastening operation, the pressing plate 81 is moved in the arrow A1 by the pressing unit 72. The direction of the arrow A1 is parallel or substantially parallel to the downward direction 105.

### Seating

FIG. 2B shows a state after seating in the stack fastening operation. When the pressing plate 81 is further pressed in the direction of the arrow A1, the lid 27 is seated on the stack case 25 as shown in FIG. 2B. An arrow A2 in FIG. 2B indicates a portion where the lid 27 is seated on the stack case 25.

### Screw Fastening

In the stack fastening operation, after the lid 27 is seated on the stack case 25, the lid 27 is screwed to the stack case 25 by using a threaded member such as the bolt 26 shown in FIG. 1.

### Limit Load

Here, the load that can be applied to the stack case after seating may be limited for the stack case. This load is referred to as a limit load. The pressing operation of the pressing unit 72 on the lid 27 via the pressing plate 81 needs to be performed within a range in which the lid 27 is seated on the stack case 25 and a load exceeding the limit load is not applied to the stack case 25.

Conventionally, the stop of the pressing operation to the lid 27 is performed based on the position of the lid 27 in the stacking direction 101, the load applied to the lid 27, or the like. Therefore, it is difficult to control the load applied to the stack case 25 at the time of seating due to the influence of variations in the thickness of the members included in the stacked body 14 or the components involved in the stack fastening.

In the apparatus 1 for manufacturing of the present embodiment, by using the contact load detection stop function, even when there is a variation in the thicknesses of the components, the stack fastening work can be performed while the load applied to the stack case 25 is made constant.

### Contact Load Detection Stop Function

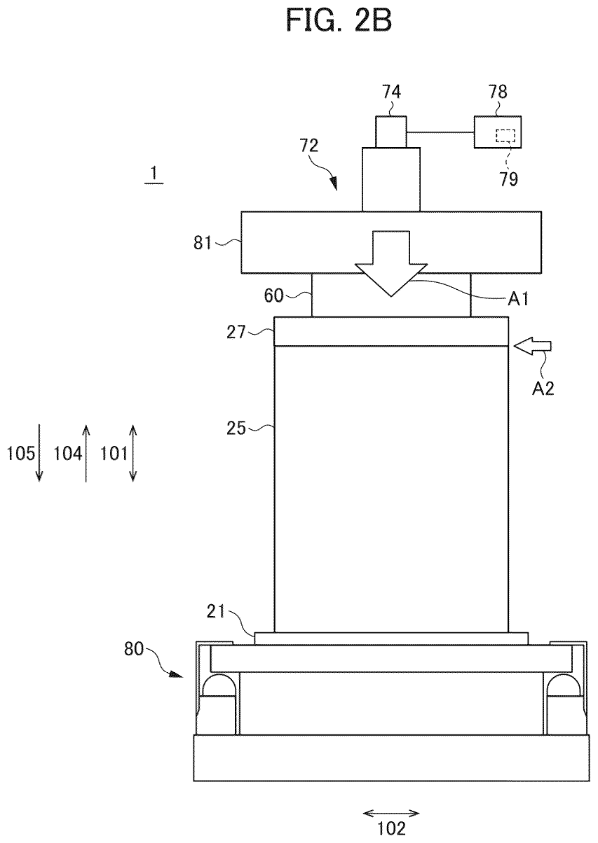

The contact load detection stop function will be described with reference to FIG. 3. FIG. 3 is a diagram for explaining an outline of determining the timing of stopping pressing by contact load detection. The X-axis in FIG. 3 represents the time T from the start of the pressing operation. The Y-axis in FIG. 3 represents the load per unit time, i.e., W/T.

In the apparatus 1 for manufacturing the present embodiment, the timing at which the pressing operation of the pressing unit 72 is stopped is determined by the load per unit time. The load per unit time when the pressing operation is stopped is set as the threshold value TH. As shown in FIG. 3, the value of the threshold TH is determined in advance. The value of the predetermined threshold TH is referred to as a first predetermined value. When the load per unit time reaches the threshold TH, the pressing operation is stopped. FIG. 3 shows a point P1 at which the load per unit time reaches the threshold TH.

As shown in FIG. 3, by determining the timing at which the pressing is stopped based on the load per unit time, the load exceeding the limit load is not applied to the stack case 25, and it is possible to fasten with the optimum load for every fuel cell stack 10.

### Calculation of Load Per Unit Time

The load per unit time (W/T) can be determined as follows. While the pressing unit 72 presses the pressing plate 81 under a predetermined condition, for example, at a constant speed, the entire load detection unit 74 detects the entire load applied to the lid 27 or the like. The load applied to the pressing plate 81 detected by the overall load detection unit 74 is inputted to the control unit 78. The control unit 78 includes a calculation unit 79. The calculation unit 79 calculates the load per unit time. In this way, the load per unit time can be obtained. The control unit 78 may calculate a change rate of the load per unit time.

### Determination of Threshold

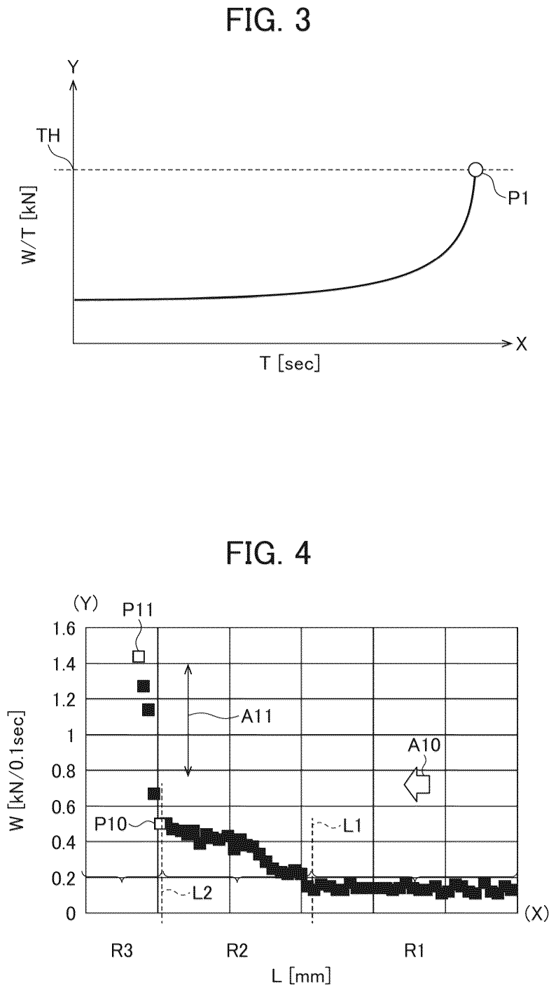

A method of determining the threshold value TH will be described with reference to FIG. 4. FIG. 4 is a graph showing the relationship between the stack length of the fuel cell stack and the load per unit time applied to the fuel cell stack by the pressing unit. The X-axis in FIG. 4 represents the stack length [mm] of the fuel cell stack. The Y-axis in FIG. 4 represents the load WkN/0.1 sec (seconds) per unit time applied to the fuel cell stack. The load per unit time applied to the fuel cell stack is recorded every 0.1 seconds. The numerical values on the Y-axis in FIG. 4 are examples. The value of the load per unit time applied to the fuel cell stack varies depending on the configuration of the fuel cell stack or the like.

An arrow A10 in FIG. 4 indicates the direction of change in the stack length L of the fuel cell stack 10 when the pressing of the fuel cell stack 10 by the pressing unit 72 proceeds. The direction indicated by the arrow A10 is referred to as a pressing direction A10. In the graph of FIG. 4, the X axis is divided into a first region R1, a second region R2, and a third region R3 in order in the pressing direction A10.

### First Region

The first region R1 is a region from the start of pressing to a line L1 in FIG. 4. The first region R1 is a region in which the stack length L of the power generation cells 12 is mainly reduced by compression. In the first region R1, the load per unit time is substantially constant. In the example shown in FIG. 4, the load per unit time is substantially constant at about 1.5 kN/sec.

### Second Region

The second region R2 is a region from the line L1 in FIG. 4 to the line L2 in FIG. 4. The second region R2 is a region in which the stack length L of a gasket (not shown) provided between the stack case 25 and the lid 27, in addition to the power generation cell 12, is reduced by compression. The gasket is provided to suppress hydrogen or the like from leaking. In the second region R2, the load per unit time gradually increases as the stack length L decreases. The reason why the tendency of the change in the load per unit time is different between the first region R1 and the second region R2 is that the gasket is compressed in the second region R2. In the second region R2, the load per unit time increases to approximately 0.5 kN/sec.

### Third Region

The third region R3 is a region from the line L2 in FIG. 4 to the pressing stop. The third region R3 is a region from when the lid 27 is seated on the stack case 25 to when the pressing is stopped. P10 in FIG. 4 indicates a time point of seating. P11 indicates a point in time of pressing stop. In the third region R3, the stack length L is not so small. This is because the stack case 25 and the lid 27 are less likely to be compressed than the power generation cells 12 and the like. In the third region R3, the load per unit time sharply rises. In the third region R3, a load is applied to the stack case 25 and the lid 27, which are unlikely to contract, rather than the power generation cell 12 or the like.

### Overshoot

The pressing from the seating P10 to the pressing stop P11 is referred to as overshoot. The load applied during the overshoot becomes the case load. The case load refers to a load applied to the stack case 25. An arrow A11 in FIG. 4 indicates the case load. For example, when the load at the time of seating P10 is 46.6 kN and the load at the time of pressing stop P11 is 51.3 kN, the case load is 4.7 kN, which is the difference therebetween.

In the manufacturing apparatus 1 of the present embodiment, the pressing is stopped when the value of the load per unit time becomes a predetermined value (threshold). The threshold is preferably a value at a time point when a predetermined pressing is performed after seating. As a result, for example, even when there is a variation in the thicknesses of the components included in the fuel cell stack 10, it is possible to suppress insufficient fastening. In the example shown in FIG. 4, the threshold is preferably set to a value equal to or greater than 0.5 kN/0.1 seconds of the load per unit time in the seating P10.

As described above, the load that may be applied to the stack case 25 after seating may be limited (limit load). The threshold is preferably set to a value at which a load exceeding the limit load is not applied to the stack case 25 due to the overshoot. In the example shown in FIG. 4, when the limit load of the stack case 25 is 10 kN, the point in time at which the load applied to the stack case 25 becomes 4.7 kN is set as the point in time of the pressing stop P11. In this case, the load per unit time as the threshold is set to a value slightly exceeding 1.4 kN/0.1 sec.

The load per unit time at the time of seating can be determined by a change in the load per unit time. As shown in FIG. 4, the load per unit time sharply increases after the seating P10. Therefore, the position at which the load per unit time starts to change at an inclination (second predetermined value) of 0.1 kN/0.1 sec or more can be defined as the seating position P10.

The present invention is not particularly limited to the above-described embodiment, and various modifications can be made without departing from the scope of the present invention.

### EXPLANATION OF REFERENCE NUMERALS

1 manufacturing apparatus

10 fuel cell stack

12 power generation cell

14 stacked body

18 first insulator

19 second insulator

21 first end plate

22 second end plate

24 coupling bar

25 stack case

26 bolt

27 lid

60 fixing member

72 pressing unit

74 overall load detection unit

78 control unit

79 calculation unit

80 holding table

81 pressing plate

101 first direction, stacking direction

102 second direction

103 third direction

A10 pressing direction

R1 first region

R2 second region

R3 third region

P10 seating

P11 pressing stop

What is claimed is:

1. An apparatus for manufacturing a fuel cell stack, the apparatus comprising:
a press that presses the fuel cell stack before fastening along a stacking direction;
an overall load detector that, when the press presses, detects a load on the fuel cell stack; and
a calculator that calculates a load per unit time for a load detected by the overall load detector,
wherein the press stops pressing in a case in which the load per unit time calculated by the calculator is equal to or greater than a first predetermined value.

2. The apparatus according to claim 1, wherein
the calculator calculates a rate of change of the load per unit time, and
the first predetermined value is a value equal to or greater than a value of the load per unit time when the rate of change becomes a second predetermined value.

3. The apparatus according to claim 2, wherein
the fuel cell stack includes a stack case, and
the first predetermined value is a value equal to or greater than a value of the load per unit time when the rate of change becomes the second predetermined value, and is a value less than a value of the load per unit time when a limit load for the stack case is applied to the stack case.
